(19) United States
(12) Patent Application Publication
(10) Pub. No.: US 2026/0264899 A1
(43) Pub. Date: Sep. 10, 2026

(54) GROUND STATION SYSTEM WITH ROTATABLE PEDESTAL

(71) Applicant: Starling, Inc., San Diego, CA (US)

(72) Inventors: Noy Kahalani, San Diego, CA (US); Kavin Gustafson, San Diego, CA (US); Jeffrey Wurzbach, San Diego, CA (US); Ido Gur, San Diego, CA (US); Omri Dayan, San Diego, CA (US)

(21) Appl. No.: 19/555,763

(22) Filed: Mar. 3, 2026

Related U.S. Application Data
(60) Provisional application No. 63/768,657, filed on Mar. 7, 2025.

(51) Int. Cl. B64U 70/90; B64U 10/20; B64U 70/60; G01P 5/07; G01P 13/02; G05D 3/10

(52) U.S. Cl. CPC B64U 70/90; B64U 10/20; B64U 70/60; G01P 5/07; G01P 13/02; G05D 3/10

(57) ABSTRACT

A ground station system for an unmanned aircraft includes a ground station and a rotatable pedestal system. The ground station includes a landing pad. The rotatable pedestal system includes a rotatable pedestal assembly, a wind sensor, and a controller operably coupled to the wind sensor and the rotatable pedestal assembly. The rotatable pedestal assembly has a rotatable pedestal that supports the ground station. The rotatable pedestal defines a rotation axis about which the rotatable pedestal rotates. The wind sensor senses wind direction and communicates a signal indicative of the wind direction to the controller. The rotatable pedestal assembly selectively rotates the rotatable pedestal about the rotation axis, based on the signal, to position the landing pad at an angular orientation relative to a sensed wind direction to reduce crosswind during landing.

### CROSS-REFERENCE TO RELATED APPLICATIONS

This application claims the benefit of U.S. Provisional Patent Application No. 63/768,657, filed on Mar. 7, 2025, the entire contents of which are hereby incorporated herein by reference.

### TECHNICAL FIELD

This disclosure relates to operable ground station systems for unmanned aircraft such as fixed-wing unmanned aerial vehicle (UAV) systems with vertical take-off and landing capability.

### BACKGROUND

Landing aircraft such as UAVs on ground stations is challenging. Under certain adverse environmental conditions, particularly when strong crosswinds are present, landing such UAVs becomes significantly more complex. Crosswinds, which occur when wind blows across the runway of the landing pad (e.g., any wind blowing in a direction over the runway that is not parallel to a length of the runway such as an acute, perpendicular, and/or obtuse angle relative to the length of the runway), pose significant risks to the safe operation of UAVs during the landing phase.

A fixed-wing vertical takeoff and landing UAV typically performs takeoff and landing using hovering motors, while aerodynamic lift surfaces such as wings, tail surfaces, and the fuselage generate significant aerodynamic forces during descent. Significant aerodynamic forces are generated during landing, which can prevent the UAV from landing at an exact position. However, drone-in-a-box applications are configured for precision landing. Crosswind during a final phase of a vertical landing often results in lateral movement of the UAV that increases the likelihood that the UAV will be unable to land at a precise location such as on a landing pad of a drone-in-a-box.

Given the anticipated growth in fixed-wing vertical takeoff and landing UAV deployments across commercial, industrial, and governmental sectors, there is a compelling need for innovative systems and methods to enhance the safety and reliability of UAV landings under crosswind conditions.

### BRIEF DESCRIPTION OF THE DRAWINGS

A better understanding of the features and advantages of the disclosed technology will be obtained by reference to the following detailed description that sets forth illustrative aspects, in which the principles of the technology are utilized, and the accompanying figures of which:

FIG. 1 is a top, perspective view of a ground station system supporting an unmanned aircraft (e.g., unmanned aerial vehicle (UAV)) on a ground station of the ground station system in accordance with the principles of this disclosure;

FIG. 2 is a bottom, perspective view of a ground station and a rotatable pedestal assembly of the ground station system of FIG. 1;

FIG. 3 is a perspective view of FIG. 1, with parts separated;

FIG. 4 is a perspective view of a rotatable pedestal system of the ground station system of FIG. 1;

FIG. 5 is a top, plan view of the rotatable pedestal assembly of the rotatable pedestal system of FIG. 4, wherein hidden features of the rotatable pedestal assembly are illustrated in broken lines for clarity;

FIG. 6 is a perspective view of a rotatable pedestal turntable and a drive gear of the rotatable pedestal assembly of FIG. 5;

FIG. 7 is a block diagram of a controller of the ground station system of FIG. 1;

FIGS. 8-10 are progressive views illustrating the ground station system of FIG. 1 rotating in response to a wind direction when the aircraft approaches the ground station to facilitate a landing of the aircraft on the ground station; and

FIG. 11 is an exemplary flow diagram of a method of rotating a ground station with the rotatable pedestal system of FIG. 4.

Further details and aspects of exemplary aspects of the disclosure are described in more detail below with reference to the appended figures. Any of the above aspects and aspects of the disclosure may be combined without departing from the scope of the disclosure.

### DETAILED DESCRIPTION

Although illustrative systems of this disclosure will be described in terms of specific aspects, it will be readily apparent to those skilled in this art that various modifications, rearrangements, and substitutions may be made without departing from the spirit of this disclosure.

For purposes of promoting an understanding of the principles of this disclosure, reference will now be made to exemplary aspects illustrated in the figures, and specific language will be used to describe the same. It will nevertheless be understood that no limitation of the scope of this disclosure is thereby intended. Any alterations and further modifications of this disclosure features illustrated herein, and any additional applications of the principles of this disclosure as illustrated herein, which would occur to one skilled in the relevant art and having possession of this disclosure, are to be considered within the scope of this disclosure.

In the following description, well-known functions or constructions are not described in detail to avoid obscuring the present disclosure in unnecessary detail.

The present disclosure addresses crosswind landing challenges by providing an advanced system and method designed to facilitate the safe and efficient landing of aircraft in the presence of crosswinds. By leveraging dynamic ground-based systems, this disclosure aims to significantly improve the operational reliability of ground stations and enhance overall aircraft (e.g., UAV) mission success.

Generally, this disclosure is directed to a ground station system having a rotatable pedestal assembly that is rotatable about a rotation axis to position any suitable movable landing surface, such as a landing pad of the ground station system, in a landing orientation based on a wind direction to enable an aircraft, such as an unmanned aerial vehicle (UAV), to safely land on the landing pad to reduce a crosswind component acting on the aircraft. Such aircraft may be UAV systems that may be tethered, non-tethered, and/or continuous flight drone systems. Once landed, the aircraft can be housed, charged, deployed, controlled (e.g., autonomously), etc. by, for example, a ground station of the ground station system. For a more detailed description of exemplary ground stations, reference can be made to, for example, U.S. Pat. No. 11,673,690, the entire contents of which are incorporated herein by reference. In some aspects, a robot, such as a 6 axis robot, may be utilized to move such aircraft from the movable landing surface to a separate location, container, storage unit, and/or ground station.

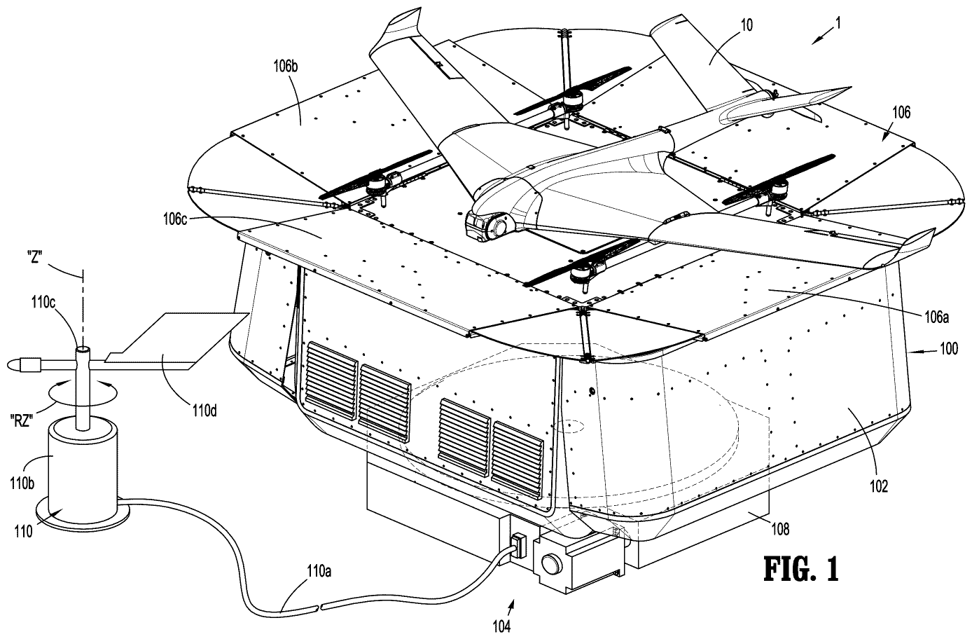

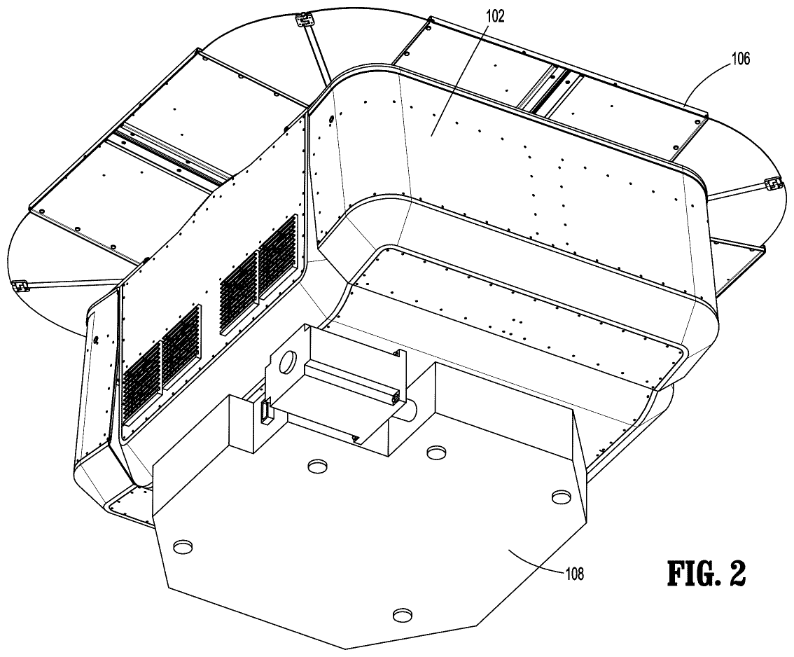

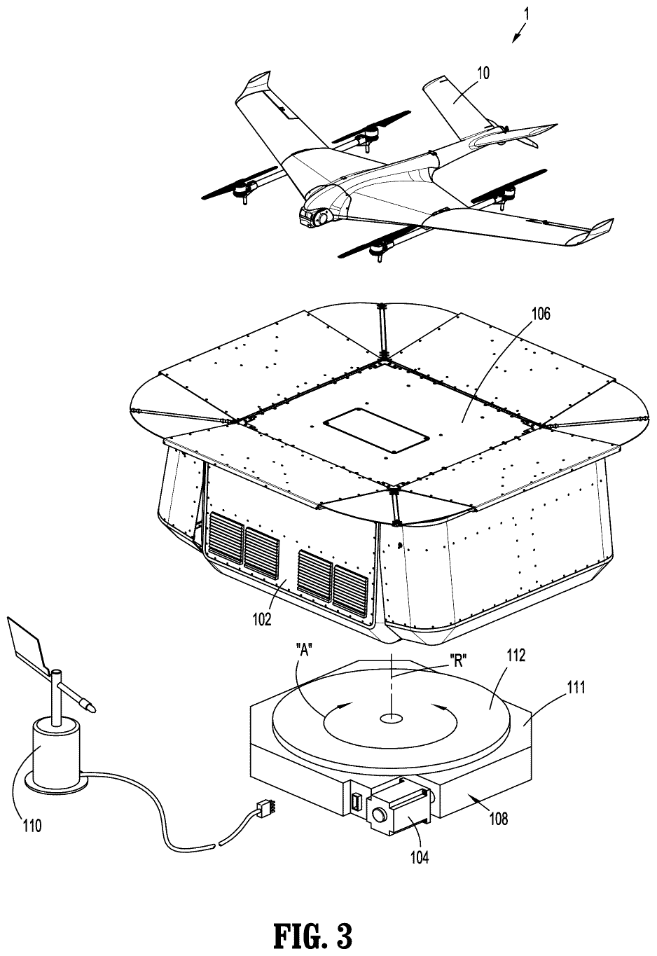

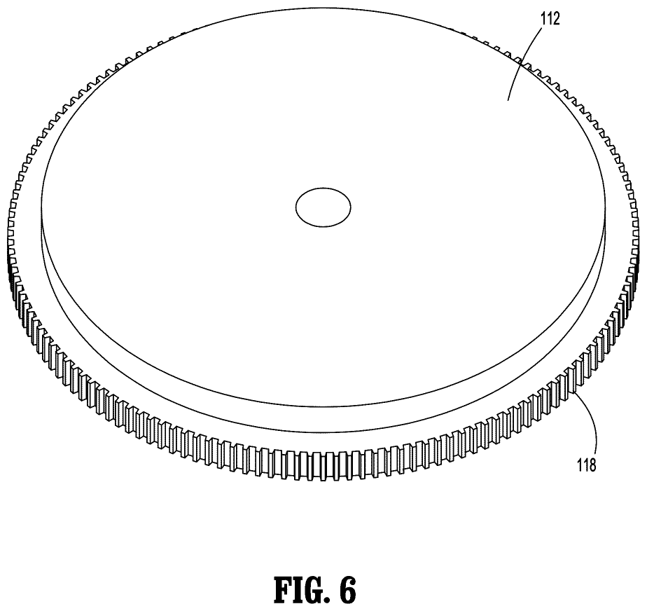

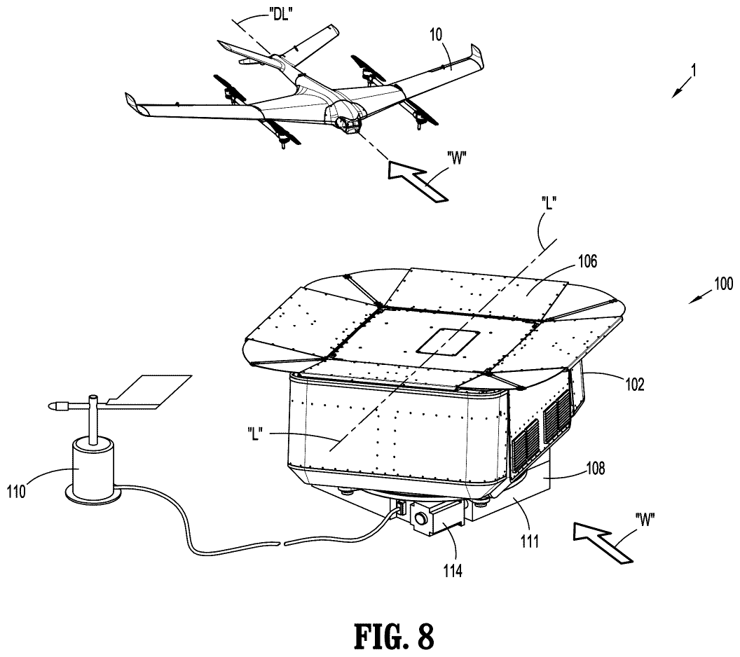

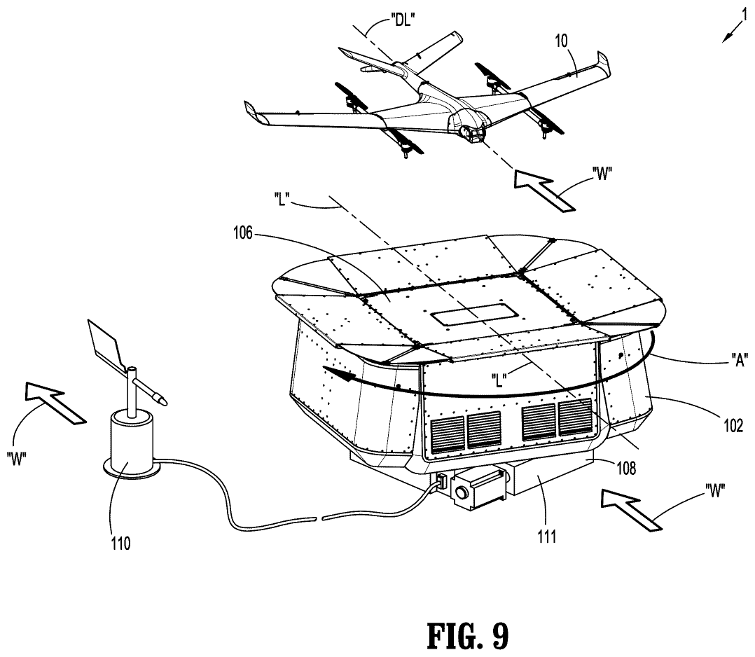

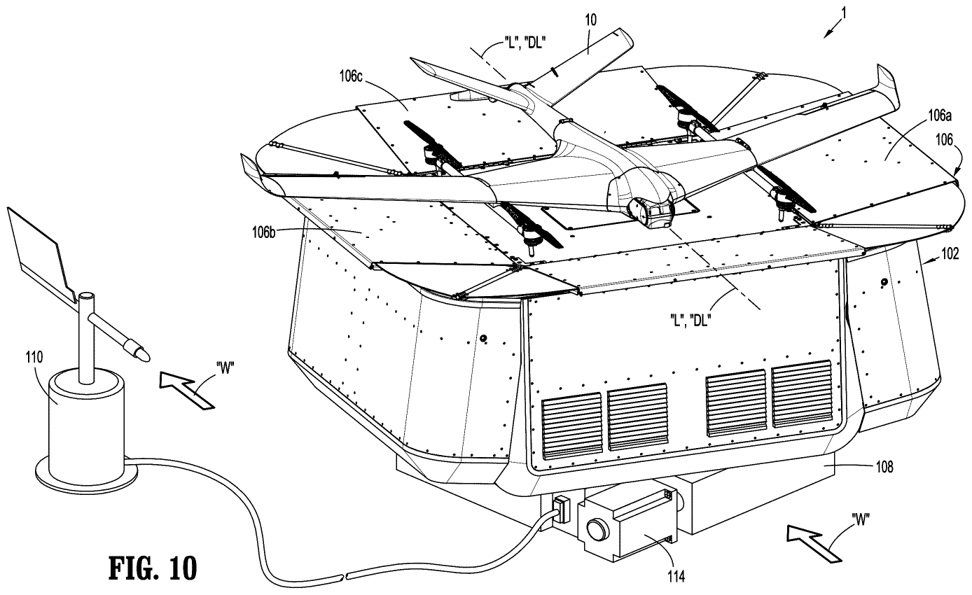

With reference to FIGS. 1-10, an unmanned aircraft ground station system 1 includes an unmanned aerial vehicle (UAV) 10, which defines a central longitudinal drone axis “DL” (see FIG. 8) and a ground station system 100 for supporting UAV 10, which can be a fixed-wing UAV.

Turning now to FIGS. 1-7, ground station system 100 includes a ground station 102 and a rotatable pedestal system 104. Ground station 102 mounts on rotatable pedestal system 104 and includes a landing pad 106 to enable UAV 10 to land on and/or take off from ground station 102. Landing pad 106 includes a central, elongated runway section 106c configured to provide a safe and efficient landing platform for a fixed-wing UAV 10, a first side section 106a extending laterally from a first side of central, elongated runway section 106c, and a second side section 106b extending laterally from a second side of central, elongated runway section 106c. In aspects, the first and second side sections 106a, 106b may be folded toward and/or away from elongated runway section 106c, for instance, when opening and/or closing the landing pad 106 and/or ground station 102. Rotatable pedestal system 104 includes a rotatable pedestal assembly 108 and a wind sensor 110 coupled to rotatable pedestal assembly 108. In aspects, wind sensor 110 is coupled to rotatable pedestal assembly 108 by a wired connection 110a (FIG. 1). In some aspects, wind sensor 110 is wirelessly coupled to rotatable pedestal assembly 108. Wind sensor 110 includes a support frame 110b, a mast 110c that defines a longitudinal rotation axis “Z,” and a wind vane 110d that rotates about longitudinal rotation axis “Z” in response to wind forces acting on wind vane 110d, as indicated by arrows “RZ.”

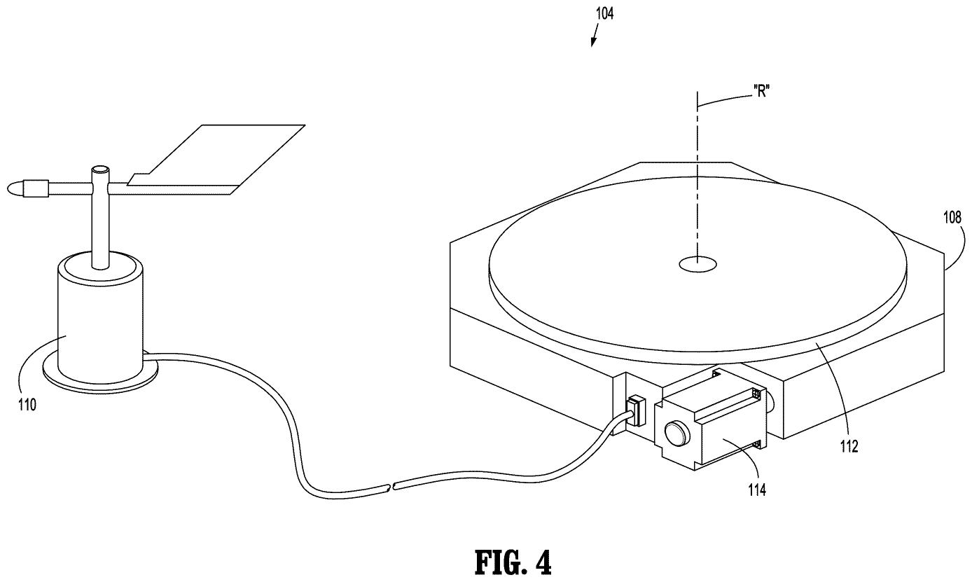

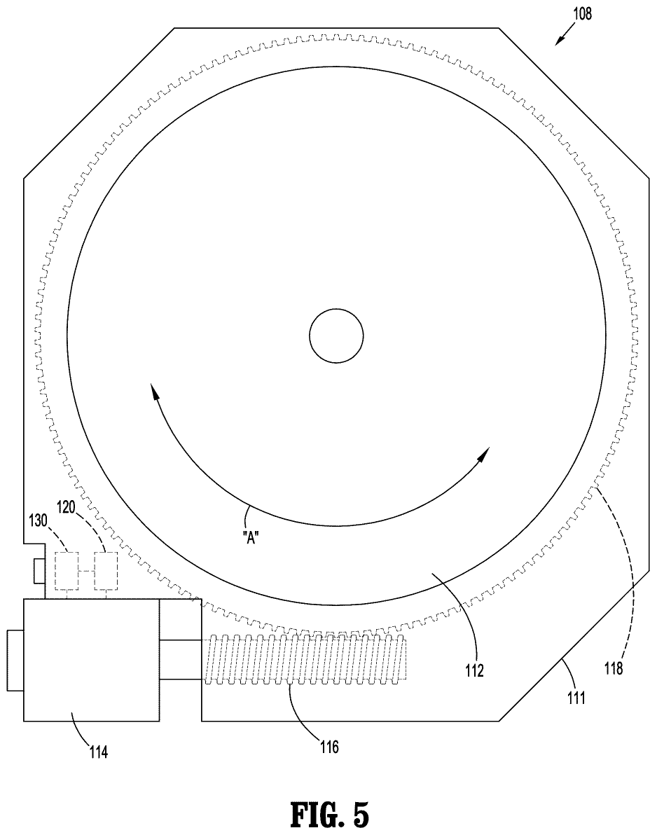

As seen in FIGS. 8-10, wind sensor 110 of ground station system 100 is configured to sense a wind direction and/or wind speed relative to landing pad 106 of ground station 102. In some aspects, wind sensor 110 is configured to communicate a signal (e.g., an electrical and/or analog signal) indicative of such wind direction and/or speed to, for example, a controller 130 (FIG. 5) of rotatable pedestal system 104 (FIG. 4) so that controller 130 can communicate with rotatable pedestal system 104 (e.g., via another signal) to cause rotatable pedestal system 104 to rotate for selectively orienting landing pad 106 in a predetermined orientation. Such predetermined orientation is determined by controller 130 based on the signal indicative of the sensed wind direction and/or speed so that such predetermined orientation of the landing pad 106 ensures UAV 10 can safely and efficiently land on landing pad 106. These predetermined orientations can correspond to any angular position along the 360-degree circumference.

In some aspects, ground station system 100 does not include a controller and rotatable pedestal system 104 is configured to rotate to such predetermined orientation in response to wind force acting on rotatable pedestal assembly 108, whereby such wind forces autonomously cause rotatable pedestal assembly 108 to rotate to such predetermined orientation. In aspects, rotatable pedestal system 104 may include one or more sails (not explicitly shown) extending from rotatable pedestal assembly 108 that receive the wind force and rotate the rotatable pedestal assembly 108 to the predetermined orientation based on the direction of the wind generating the wind force. In alternative aspects, the rotatable pedestal assembly may be mechanically configured to rotate in response to wind forces without electronic control, such that a controller is omitted.

The predetermined orientations of landing pad 106 may be provided in the form of cardinal directions or runway designations, ensuring proper alignment with environmental and operational requirements. For UAVs that require runway-like pads, such as fixed-wing models, these predetermined orientations may be based on compass bearings. These bearings may be expressed in degrees (e.g., 090° for east or 270° for west) for indicating a heading (e.g., a magnetic or true heading) of the orientation of landing pad 106. The rotatable pedestal assembly 108 is configured to rotate the landing pad 106 relative to prevailing wind directions “W” (see FIGS. 8-10), as landing into the wind provides stability and reduces ground speed during descent. Additionally, landing pad 106 can be rotated to a position that provides a clear glide path, to enable the UAV 10 to be free from obstacles such as buildings or trees. For autonomous systems, the landing orientation may be tied to a designated home location or GPS waypoint, with an approach direction programmed relative to this point.

In aspects, wind sensor 110 is a passive structure that is separate (e.g., disconnected) from ground station 102. For instance, in one example, a wind sensor 110 is in an analog form that includes a sail on lever arm (not explicitly shown), whereby positions of the sail relative to the lever arm provides an indication of wind direction. Rotatable pedestal system 104 may be rotated (e.g., via a remote operator) in response to changes in wind direction indicated by such wind sensor.

Landing pad 106 of ground station 102 is configured to have a runway type configuration in which proper orientation enables a safe and efficient runway landing for fixed-wing UAV such as UAV 10. In a runway landing, an aircraft approaches a runway at an angle (glide path) and touches down horizontally while moving forward. In contrast, in a vertical landing, such as for vertical takeoff and landing (VTOL) aircraft, like helicopters, the aircraft descends directly downward onto a landing zone without forward movement or needing a runway. As noted above, one key factor is wind direction, as many UAVs, particularly fixed-wing types, require landing into the wind to minimize ground speed and maintain stability during descent. Additionally, automated landing systems rely on precise guidance, and the orientation of landing pad 106 is configured to match the UAV's pre-programmed flight path or GPS coordinates. Obstacle avoidance may also play a role, with landing pad 106 being rotatable to one or more positions for providing a clear path free of obstructions such as trees, buildings, or power lines. Operational efficiency is another consideration, as the orientation of landing pad 106 is configured to minimize turnaround time during deployment and recovery. Visual markings, lights, or sensors (not explicitly shown) may be provided on landing pad 106 to guide the UAV 10 e.g., for safe landing.

As best seen in FIG. 5, rotatable pedestal assembly 108 of rotatable pedestal system 104 includes a support base 111 that can be secured to, formed with, and/or mounted on any suitable surface, a rotatable pedestal 112 rotatably mounted on support base 111, a motor 114, an input drive 116 coupled to motor 114, an output drive 118 coupled to rotatable pedestal 112 and operably coupled to input drive 116, a power source 120 coupled to motor 114, and a controller 130 operably coupled to motor 114 and power source 120. In aspects, motor 114 includes a servo, an actuator such as a linear actuator, and/or any other suitable motors. Controller 130, in aspects, is operably coupled to wind sensor 110 (see FIG. 4). Wind sensor 110 may include or communicate with a remote and/or cloud server/provider that stores and/or transmits wind data (e.g., real-time data) to controller 130. Controller 130 is configured to selectively actuate motor 114 based on a signal received from wind sensor 110 and/or the remote and/or cloud server/provider. Motor 114 is configured to actuate input drive 116 and/or output drive 118, which may be any suitable mechanical and/or electrical driving mechanism including one or more gears, cams, followers, belts, pulleys, magnets, actuators, etc. supported for instance, in support base 111, that cooperate to cause rotatable pedestal 112 to rotate to one or more predetermined orientations relative to support base 111. For example, input drive 116 may be a worm gear and output drive 118 may be a worm wheel that is secured to the rotatable pedestal 112 so that rotatable pedestal 112 rotates when the input drive 116 rotates the output drive 118.

Rotatable pedestal 112 of rotatable pedestal assembly 108 is rotatable about a rotation axis “R” (FIG. 4) defined through a center of rotatable pedestal 112 in the clockwise and/or counterclockwise directions, as indicated by arrows “A” and relative to support base 111 (see also FIG. 8). Rotatable pedestal 112 is configured to support ground station 102 on a top surface of rotatable pedestal 112. In aspects, rotatable pedestal 112 may be secured to, for example, a bottom surface of ground station 102, by, for instance, one or more fasteners such as screws (not explicitly shown) to enable ground station 102 to rotate with rotatable pedestal 112 relative to support base 111 as rotatable pedestal 112 rotates relative to support base 111. In aspects, rotatable pedestal 112 is integrally formed (e.g., monolithically) with ground station 102. In some aspects, support base 111 is fixedly coupled to a surface. For instance, in some aspects, support base 111 is cast in concrete supported by and/or within a ground surface, and/or bolted and/or fastened to a fixed surface formed of any suitable material (e.g., wood, steel, polymer, alloy, and/or other composite material, etc.)

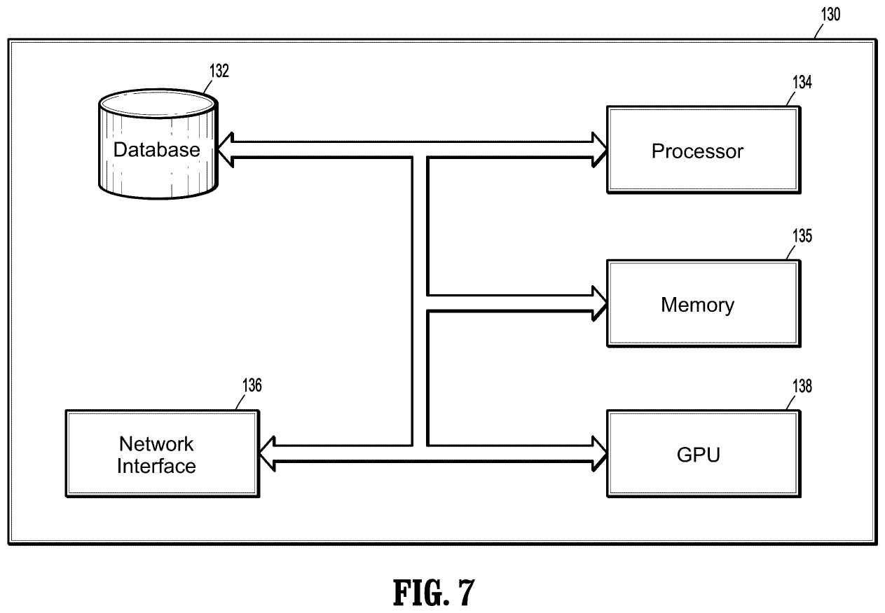

Referring now to FIG. 7, exemplary components in controller 130 in accordance with aspects of the present disclosure include, for example, a database 132 (e.g., storage), a processor 134, a memory 135, and a network interface 136. In aspects, controller 130 may include a graphical processing unit (GPU) 138.

Database 132 of controller 130 can be located in storage. The term “storage” may refer to any device or material from which information may be capable of being accessed, reproduced, and/or held in, for example, an electromagnetic or optical form (and/or flash memory), for access by a computer processor. Storage may be, for example, volatile memory such as RAM, non-volatile memory, which permanently holds digital data until purposely erased, such as flash memory, magnetic devices such as hard disk drives, and optical media such as a CD, DVD, Blu-ray Disc™, or the like.

In various aspects, data may be stored on controller 130, including, for example, user preferences, historical data, and/or other data. The data can be stored in database 132 and sent via a system bus to processor 134.

Processor 134 of controller 130 executes various processes utilizing the data from database 132 based on instructions that can be stored in the memory 135. A request from a user device, such as a mobile device or a client computer, which may include remote calls from an offsite/remote/cloud service, and/or a signal from a sensor (e.g., wind sensor 110) can be communicated to the controller 130 through network interface 136. In aspects, wind sensor 110 is a local sensor and/or a remote sensor such as a weather software as a service. The illustration of FIG. 7 is exemplary, and controller 130 can include any other suitable components that may exist in a controller 130. Such other components are not illustrated in FIG. 7 for clarity of illustration.

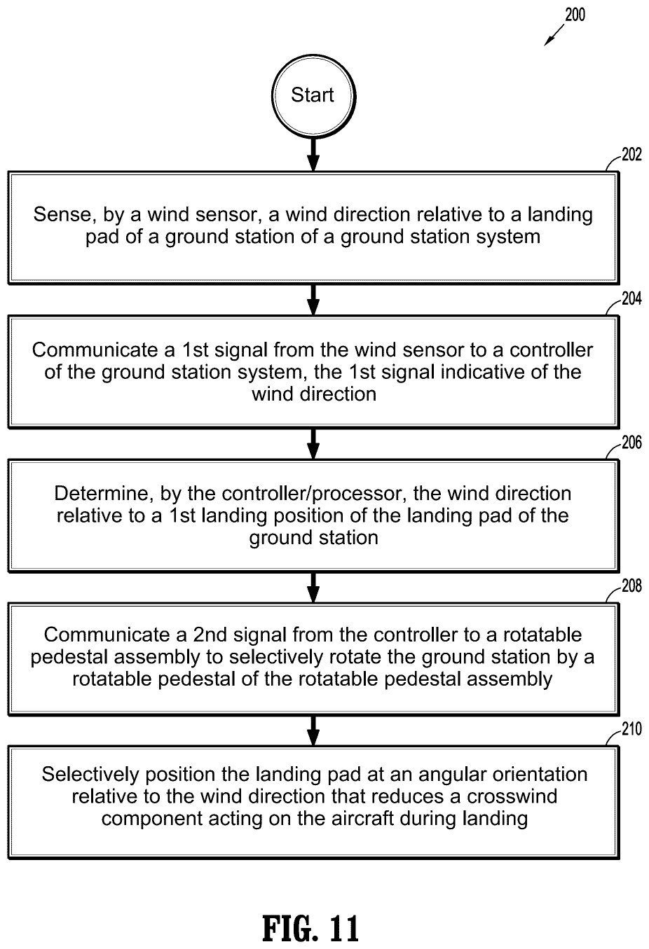

With reference to FIG. 11, a flow diagram for a method 200 of rotating a ground station with the rotatable pedestal system 104 is shown. Although the steps of FIG. 11 are shown in a particular order, the steps need not all be performed in the specified order, and certain steps can be performed in another order. For example, FIG. 11 is described with controller 130 (FIG. 7) performing the operations. In various aspects, the operations depicted in FIG. 11 may be performed all or in part by the controller 130 of FIG. 7. In aspects, the operations depicted in FIG. 11 may be performed all or in part by another device, for example, a mobile device and/or a remote computer system. These and other variations are contemplated to be within the scope of the present disclosure.

Initially, at step 202, wind sensor 110 of ground station system 100 senses a wind direction “W” relative to a position and/or an orientation of elongated runway section 106c of landing pad 106 of ground station 102 (and/or a longitudinal axis “L” thereof). At step 204, wind sensor 110 communicates a first signal indicative of the wind direction “W” relative to the position and/or orientation of elongated runway section 106c of landing pad 106 (and/or the longitudinal axis “L” thereof) to controller 130 of ground station system 100.

At step 206, controller 130 of ground station system 100 receives the first signal and determines the wind direction “W” relative to the position and/or the orientation of elongated runway section 106c of landing pad 106 (e.g., the initial or current position/orientation of elongated runway section 106c, such as an orientation in which central, elongated runway section 106c and/or longitudinal axis “L” thereof is misaligned with the wind direction “W”). Controller 130 then determines in which direction and/or how far to rotate the rotatable pedestal 112 relative to support base 111 so as to orient landing pad 106 at an angular position relative to the sensed wind direction that reduces a crosswind component acting on UAV 10 during landing. In some aspects, this orientation can correspond to substantial alignment of a longitudinal axis of the landing pad 106 with the wind direction, although exact parallelism is not required.

At step 208, controller 130 generates a second signal indicative of the rotation direction and how far rotatable pedestal 112 should be rotated (e.g., how many degrees of rotation about rotation axis “R”) to effectuate such angular positioning of landing pad 106 relative to the wind direction “W.”

At step 210, controller 130 then communicates the second signal from controller 130 to motor 114 to actuate motor 114. This second signal causes input and/or output drives 116, 118 to rotate rotatable pedestal 112 to a second position. This second position is a landing orientation where landing pad 106 is positioned at an angular orientation relative to the wind direction ‘W’ that reduces a crosswind component acting on an aircraft, such as fixed-wing UAV 10, during landing.

It should be understood that the disclosed structure can include any suitable mechanical, electrical, and/or chemical components for operating the disclosed system or components thereof. For instance, such electrical components can include, for example, any suitable electrical and/or electromechanical, and/or electrochemical circuitry, which may include or be coupled to one or more printed circuit boards. As appreciated, the disclosed computing devices and/or server can include, for example, a “controller,” “processor,” “digital processing device” and like terms, and which are used to indicate a microprocessor or central processing unit (CPU). The CPU is the electronic circuitry within a computer that carries out the instructions of a computer program by performing the basic arithmetic, logical, control and input/output (I/O) operations specified by the instructions, and by way of non-limiting examples, include server computers. In some aspects, the controller includes an operating system configured to perform executable instructions. The operating system is, for example, software, including programs and data, which manages hardware of the disclosed apparatus and provides services for execution of applications for use with the disclosed apparatus. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. In some aspects, the operating system is provided by cloud computing.

In some aspects, the term “controller” may be used to indicate a device that controls the transfer of data from a computer or computing device to a peripheral or separate device and vice versa, and/or a mechanical and/or electromechanical device (e.g., a lever, knob, etc.) that mechanically operates and/or actuates a peripheral or separate device.

In aspects, the controller includes a storage and/or memory device. The storage and/or memory device is one or more physical apparatus used to store data or programs on a temporary or permanent basis. In some aspects, the controller includes volatile memory and requires power to maintain stored information. In various aspects, the controller includes non-volatile memory and retains stored information when it is not powered. In some aspects, the non-volatile memory includes flash memory. In some aspects, the non-volatile memory includes ferroelectric random-access memory (FRAM). In various aspects, the non-volatile memory includes phase-change random access memory (PRAM). In certain aspects, the controller is a storage device including, by way of non-limiting examples, CD-ROMs, DVDs, flash memory devices, magnetic disk drives, magnetic tapes drives, optical disk drives, and cloud-computing-based storage. In various aspects, the storage and/or memory device is a combination of devices such as those disclosed herein.

In various aspects, the memory can be random access memory, read-only memory, magnetic disk memory, solid state memory, optical disc memory, and/or another type of memory. In various aspects, the memory can be separate from the controller and can communicate with the processor through communication buses of a circuit board and/or through communication cables such as serial ATA cables or other types of cables. The memory includes computer-readable instructions that are executable by the processor to operate the controller. In various aspects, the controller may include a wireless network interface to communicate with other computers or a server. In aspects, a storage device may be used for storing data. In various aspects, the processor may be, for example, without limitation, a digital signal processor, a microprocessor, an ASIC, a graphics processing unit (“GPU”), field-programmable gate array (“FPGA”), or a central processing unit (“CPU”).

Although illustrated as part of the disclosed structure, it is also contemplated that a controller may be remote from the disclosed structure (e.g., on a remote server), and accessible by the disclosed structure via a wired or wireless connection. In aspects where the controller is remote, it is contemplated that the controller may be accessible by, and connected to, multiple structures and/or components of the disclosed system.

The term “application” may include a computer program designed to perform particular functions, tasks, or activities for the benefit of a user. Application may refer to, for example, software running locally or remotely, as a standalone program or in a web browser, or other software which would be understood by one skilled in the art to be an application. An application may run on the disclosed controllers or on a user device, including for example, on a mobile device, an IOT device, or a server system.

In some aspects, the controller includes a display to send visual information to a user. In various aspects, the display is a cathode ray tube (CRT). In various aspects, the display is a liquid crystal display (LCD). In certain aspects, the display is a thin film transistor liquid crystal display (TFT-LCD). In aspects, the display is an organic light emitting diode (OLED) display. In certain aspects, on OLED display is a passive-matrix OLED (PMOLED) or active-matrix OLED (AMOLED) display. In aspects, the display is a plasma display. In certain aspects, the display is a video projector. In various aspects, the display is interactive (e.g., having a touch screen or a sensor such as a camera, a 3D sensor, a LiDAR, a radar, etc.) that can detect user interactions/gestures/responses and the like. In some aspects, the display includes vacuum fluorescent displays (VFD) and/or seven segment LED displays. In some aspects, the display is a combination of devices such as those disclosed herein.

The controller may include or be coupled to a server and/or a network. As used herein, the term “server” includes “computer server,” “central server,” “main server,” and like terms to indicate a computer or device on a network that manages the disclosed apparatus, components thereof, and/or resources thereof. As used herein, the term “network” can include any network technology including, for instance, a cellular data network, a wired network, a fiber-optic network, a satellite network, and/or an IEEE 802.11a/b/g/n/ac wireless network, among others.

In various aspects, the controller can be coupled to a mesh network. As used herein, a “mesh network” is a network topology in which each node relays data for the network. All mesh nodes cooperate in the distribution of data in the network. It can be applied to both wired and wireless networks. Wireless mesh networks can be considered a type of “Wireless ad hoc” network. Thus, wireless mesh networks are closely related to Mobile ad hoc networks (MANETs). Although MANETs are not restricted to a specific mesh network topology, Wireless ad hoc networks or MANETs can take any form of network topology. Mesh networks can relay messages using either a flooding technique or a routing technique. With routing, the message is propagated along a path by hopping from node to node until it reaches its destination. To ensure that all its paths are available, the network must allow for continuous connections and must reconfigure itself around broken paths, using self-healing algorithms such as Shortest Path Bridging. Self-healing allows a routing-based network to operate when a node breaks down or when a connection becomes unreliable. As a result, the network is typically quite reliable, as there is often more than one path between a source and a destination in the network. This concept can also apply to wired networks and to software interaction. A mesh network whose nodes are all connected to each other is a fully connected network.

In some aspects, the controller may include one or more modules. As used herein, the term “module” and like terms are used to indicate a self-contained hardware component of the central server, which in turn includes software modules. In software, a module is a part of a program. Programs are composed of one or more independently developed modules that are not combined until the program is linked. A single module can contain one or several routines, or sections of programs that perform a particular task.

As used herein, the controller includes software modules for managing various aspects and functions of the disclosed system or components thereof.

The disclosed structure may also utilize one or more controllers to receive various information and transform the received information to generate an output. The controller may include any type of computing device, computational circuit, or any type of processor or processing circuit capable of executing a series of instructions that are stored in memory. The controller may include multiple processors and/or multicore central processing units (CPUs) and may include any type of processor, such as a microprocessor, digital signal processor, microcontroller, programmable logic device (PLD), field programmable gate array (FPGA), or the like. The controller may also include a memory to store data and/or instructions that, when executed by the one or more processors, cause the one or more processors to perform one or more methods and/or algorithms.

The disclosed ground station system provides several technical advantages. By enabling rotation of the landing pad relative to a sensed wind direction, the system can reduce a crosswind component acting on an unmanned aircraft during landing, thereby improving landing stability and positional accuracy. The rotatable pedestal assembly allows dynamic adaptation to changing environmental conditions without requiring modification of the aircraft itself. In certain aspects, the system may enhance landing reliability in drone-in-a-box applications, improve operational efficiency, and reduce the likelihood of missed landings or lateral drift. Because the landing pad orientation is controlled relative to detected wind conditions, the system may also facilitate more consistent autonomous landing performance across varying deployment environments. These and other advantages may be achieved in various aspects of the disclosure.

Further aspects of the present disclosure are provided by the subject matter of the following clauses.

A ground station system for an unmanned aircraft, the ground station system comprising: a ground station including a landing pad and a rotatable pedestal system. The rotatable pedestal system includes a rotatable pedestal assembly, a wind sensor, and a controller operably coupled to the wind sensor and the rotatable pedestal assembly. The rotatable pedestal assembly has a rotatable pedestal that supports the ground station. The rotatable pedestal defines a rotation axis about which the rotatable pedestal rotates. The wind sensor is configured to sense wind direction and communicate a signal indicative of a wind direction to the controller. The rotatable pedestal assembly is configured to selectively rotate the rotatable pedestal about the rotation axis, based on the signal, to orient the landing pad relative to the sensed wind direction so as to reduce a crosswind component experienced by the unmanned aircraft during landing.

The ground station system according to the preceding clause, wherein the rotatable pedestal is secured to the ground station by at least one fastener.

The ground station system according to any of the preceding clauses, wherein the rotatable pedestal system includes a motor that is operably coupled to the controller, the controller configured to actuate the motor based on the signal.

The ground station system according to any of the preceding clauses, wherein the wind sensor is coupled to the rotatable pedestal assembly by a wired connection.

The ground station system according to any of the preceding clauses, wherein the wind sensor includes a support frame, a mast extending from the support frame, and a wind vane connected to the mast, the wind vane positioned to rotate about the mast in response to a wind force acting on the wind vane.

The ground station system according to any of the preceding clauses, wherein the controller actuates the rotatable pedestal in response to rotation of the wind vane about the mast.

The ground station system according to any of the preceding clauses, wherein the landing pad includes an elongated runway section configured to enable the unmanned aircraft to land on the landing pad via a runway landing.

The ground station system any of the preceding clauses, wherein the motor is operably coupled to an input drive that is actuatable to rotate the rotatable pedestal.

The ground station system any of the preceding clauses, wherein the input drive is operably coupled to an output drive and the output drive is operably coupled to the rotatable pedestal.

The ground station system any of the preceding clauses, further comprising a power source that powers the rotatable pedestal system.

An aircraft ground station system, comprising: an unmanned aerial vehicle (UAV), a ground station including a landing pad configured to support the UAV, a rotatable pedestal assembly having a rotatable pedestal that supports the ground station, a wind sensor, and a controller operably coupled to the wind sensor and the rotatable pedestal assembly. The rotatable pedestal defines a rotation axis about which the rotatable pedestal rotates. The wind sensor is configured to sense wind direction and communicate a signal indicative of a wind direction to the controller. The controller is configured to cause the rotatable pedestal to rotate about the rotation axis, in response to the signal indicative of wind direction, to orient the landing pad based at least in part on the sensed wind direction.

The aircraft ground station system according to the preceding clause, wherein the rotatable pedestal is secured to the ground station by at least one fastener.

The aircraft ground station system according to any of the preceding clauses, wherein the rotatable pedestal assembly includes a motor that is operably coupled to the controller, the controller configured to actuate the motor based on the signal.

The aircraft ground station system according to any of the preceding clauses, wherein the wind sensor is wirelessly coupled to the rotatable pedestal assembly.

The aircraft ground station system according to any of the preceding clauses, wherein the wind sensor includes a wind vane positioned to rotate in response to a wind force acting on the wind vane to enable the wind sensor to sense the wind direction.

The aircraft ground station system according to any of the preceding clauses, wherein the controller actuates the rotatable pedestal in response to rotation of the wind vane.

The aircraft ground station system according to any of the preceding clauses, wherein the landing pad includes an elongated runway section configured to enable the UAV to land on the landing pad via a runway landing.

The aircraft ground station system according to any of the preceding clauses, wherein the motor is operably coupled to an input drive that is actuatable to rotate the rotatable pedestal.

The aircraft ground station system according to any of the preceding clauses, wherein the input drive is operably coupled to an output drive and the output drive is operably coupled to the rotatable pedestal.

An aircraft ground station system for an unmanned aerial vehicle (UAV), the aircraft ground station system comprising: a ground station including a landing pad, a rotatable pedestal assembly having a rotatable pedestal that supports the ground station, a wind sensor, a processor, and a memory coupled to the processor. The memory has instructions stored thereon, which when executed by the processor, cause the system to: sense, by the wind sensor, a wind direction and communicate a signal indicative of the wind direction to the processor; and selectively rotate the rotatable pedestal based on the signal to position the landing pad at an angular orientation relative to the wind direction that reduces crosswind acting on the UAV during landing.

A method of operating a ground station system comprises sensing a wind direction; determining a misalignment between a longitudinal axis of a landing pad and the wind direction; and rotating a pedestal supporting the landing pad to align the longitudinal axis with the wind direction.

As can be appreciated, securement of any of the components of the disclosed systems can be effectuated using known securement techniques such welding, crimping, gluing, fastening, injection molding, cast-in-place, etc.

The phrases “in an aspect,” “in aspects,” “in various aspects,” “in some aspects,” or “in other aspects” may each refer to one or more of the same or different aspects in accordance with the present disclosure. Similarly, the phrases “in an aspect,” “in aspects,” “in various aspects,” “in some aspects,” or “in other aspects” may each refer to one or more of the same or different aspects in accordance with the present disclosure. A phrase in the form “A or B” means “(A), (B), or (A and B).” A phrase in the form “at least one of A, B, or C” means “(A); (B); (C); (A and B); (A and C); (B and C); or (A, B, and C).”

It should be understood that various aspects disclosed herein may be combined in different combinations than the combinations specifically presented in the description and accompanying drawings. It should also be understood that, depending on the example, certain acts or events of any of the processes or methods described herein may be performed in a different sequence, may be added, merged, or left out altogether (e.g., all described acts or events may not be necessary to carry out the techniques).

Certain aspects of the present disclosure may include some, all, or none of the above advantages and/or one or more other advantages readily apparent to those skilled in the art from the drawings, descriptions, and claims included herein. Moreover, while specific advantages have been enumerated above, the various aspects of the present disclosure may include all, some, or none of the enumerated advantages and/or other advantages not specifically enumerated above.

The aspects disclosed herein are examples of the disclosure and may be embodied in various forms. For instance, although certain aspects herein are described as separate aspects, each of the aspects herein may be combined with one or more of the other aspects herein. Specific structural and functional details disclosed herein are not to be interpreted as limiting, but as a basis for the claims and as a representative basis for teaching one skilled in the art to variously employ the present disclosure in virtually any appropriately detailed structure. Like reference numerals may refer to similar or identical elements throughout the description of the figures.

Any of the herein described methods, programs, algorithms or codes may be converted to, or expressed in, a programming language or computer program. The terms “programming language” and “computer program,” as used herein, each include any language used to specify instructions to a computer, and include (but is not limited to) the following languages and their derivatives: Assembler, Basic, Batch files, BCPL, C, C+, C++, Delphi, Fortran, Java, JavaScript, machine code, operating system command languages, Pascal, Perl, PL1, scripting languages, Visual Basic, metalanguages which themselves specify programs, and all first, second, third, fourth, fifth, or further generation computer languages. Also included are database and other data schemas, and any other meta-languages. No distinction is made between languages which are interpreted, compiled, or use both compiled and interpreted approaches. No distinction is made between compiled and source versions of a program. Thus, reference to a program, where the programming language could exist in more than one state (such as source, compiled, object, or linked) is a reference to any and all such states. Reference to a program may encompass the actual instructions and/or the intent of those instructions.

Persons skilled in the art will understand that the structures and methods specifically described herein and illustrated in the accompanying figures are non-limiting exemplary aspects, and that the description, disclosure, and figures should be construed merely as exemplary of particular aspects. It is to be understood, therefore, that this disclosure is not limited to the precise aspects described, and that various other changes and modifications may be effectuated by one skilled in the art without departing from the scope or spirit of the disclosure. Additionally, it is envisioned that the elements and features illustrated or described in connection with one exemplary aspect may be combined with the elements and features of another without departing from the scope of this disclosure, and that such modifications and variations are also intended to be included within the scope of this disclosure. Indeed, any combination of any of the disclosed elements and features is within the scope of this disclosure. Accordingly, the subject matter of this disclosure is not to be limited by what has been particularly shown and described.

What is claimed is:

1. A ground station system for an unmanned aircraft, the ground station system comprising:
a ground station including a landing pad; and
a rotatable pedestal system including a rotatable pedestal assembly, a wind sensor, and a controller operably coupled to the wind sensor and the rotatable pedestal assembly, the rotatable pedestal assembly having a rotatable pedestal that supports the ground station, the rotatable pedestal defining a rotation axis about which the rotatable pedestal rotates, the wind sensor configured to sense wind direction and communicate a signal indicative of a wind direction to the controller, the rotatable pedestal assembly configured to selectively rotate the rotatable pedestal about the rotation axis, based on the signal indicative of the wind direction, to position the landing pad at an angular orientation relative to the wind direction that reduces a crosswind component acting on the unmanned aircraft during landing.

2. The ground station system according to claim 1, wherein the rotatable pedestal is secured to the ground station by at least one fastener.

3. The ground station system according to claim 1, wherein the rotatable pedestal system includes a motor that is operably coupled to the controller, the controller configured to actuate the motor based on the signal.

4. The ground station system according to claim 1, wherein the wind sensor is coupled to the rotatable pedestal assembly by a wired connection.

5. The ground station system according to claim 1, wherein the wind sensor includes a support frame, a mast extending from the support frame, and a wind vane connected to the mast, the wind vane positioned to rotate about the mast in response to a wind force acting on the wind vane.

6. The ground station system according to claim 5, wherein the controller actuates the rotatable pedestal in response to rotation of the wind vane about the mast.

7. The ground station system according to claim 1, wherein the landing pad includes an elongated runway section configured to enable the unmanned aircraft to land on the landing pad via a runway landing.

8. The ground station system according to claim 3, wherein the motor is operably coupled to an input drive that is actuatable to rotate the rotatable pedestal.

9. The ground station system according to claim 8, wherein the input drive is operably coupled to an output drive and the output drive is operably coupled to the rotatable pedestal.

10. The ground station system according to claim 1, further comprising a power source that powers the rotatable pedestal system.

11. An aircraft ground station system, comprising:
an unmanned aerial vehicle (UAV);
a ground station including a landing pad configured to support the UAV;
a rotatable pedestal assembly having a rotatable pedestal that supports the ground station;
a wind sensor; and
a controller operably coupled to the wind sensor and the rotatable pedestal assembly, the rotatable pedestal defining a rotation axis about which the rotatable pedestal rotates, the wind sensor configured to sense wind direction and communicate a signal indicative of a wind direction to the controller, the controller configured to cause the rotatable pedestal to rotate about the rotation axis, in response to the signal indicative of wind direction, to orient the landing pad based at least in part on the sensed wind direction.

12. The aircraft ground station system according to claim 11, wherein the rotatable pedestal is secured to the ground station by at least one fastener.

13. The aircraft ground station system according to claim 11, wherein the rotatable pedestal assembly includes a motor that is operably coupled to the controller, the controller configured to actuate the motor based on the signal.

14. The aircraft ground station system according to claim 11, wherein the wind sensor is wirelessly coupled to the rotatable pedestal assembly.

15. The aircraft ground station system according to claim 11, wherein the wind sensor includes a wind vane positioned to rotate in response to a wind force acting on the wind vane to enable the wind sensor to sense the wind direction.

16. The aircraft ground station system according to claim 15, wherein the controller actuates the rotatable pedestal in response to rotation of the wind vane.

17. The aircraft ground station system according to claim 11, wherein the landing pad includes an elongated runway section configured to enable the UAV to land on the landing pad via a runway landing.

18. The aircraft ground station system according to claim 13, wherein the motor is operably coupled to an input drive that is actuatable to rotate the rotatable pedestal.

19. The aircraft ground station system according to claim 18, wherein the input drive is operably coupled to an output drive and the output drive is operably coupled to the rotatable pedestal.

20. An aircraft ground station system for an unmanned aerial vehicle (UAV), the aircraft ground station system comprising:
a ground station including a landing pad;
a rotatable pedestal assembly having a rotatable pedestal that supports the ground station;
a wind sensor;
a processor; and
a memory coupled to the processor and having instructions stored thereon, which when executed by the processor, cause the system to:
sense, by the wind sensor, a wind direction and communicate a signal indicative of the wind direction to the processor; and
selectively rotate the rotatable pedestal based on the signal to position the landing pad at an angular orientation relative to the wind direction that reduces crosswind acting on the UAV during landing.
